(19) United States
(12) Patent Application Publication
(10) Pub. No.: US 2015/0101581 A1
(43) Pub. Date: Apr. 16, 2015

(54) METHOD OF CONTROLLING THE PRESSURE OF A TURBOCHARGER

(71) Applicant: GM GLOBAL TECHNOLOGY OPERATIONS LLC, Detroit, MI (US)

(72) Inventors: Nihad Karacic, Mainz (DE); Nils Oth, Darmstadt (DE)

(21) Appl. No.: 14/514,138

(22) Filed: Oct. 14, 2014

(30) Foreign Application Priority Data
Oct. 14, 2013 (GB) 1318138.3

(51) Int. Cl. F02D 41/00; F02M 25/07

(52) U.S. Cl. CPC F02D 41/005; F02M 25/0772
USPC 123/568.21

(57) ABSTRACT

A method and apparatus for controlling a boost pressure of a turbocharger is provided. The turbocharger includes a waste gate valve and a waste gate actuator. When the internal combustion engine operates under cold temperature conditions, a steady state temperature of the waste gate actuator is determined and a corrected temperature of the waste gate actuator is estimated as a function of the thermal convection between ambient air and the waste gate actuator. A corrected value of the duty cycle of a pulse width modulated signal is estimated as a function of said corrected temperature and the duty cycle corrected value is used to control the boost pressure of the turbocharger.

### CROSS REFERENCE TO RELATED APPLICATION

This application claims priority to British Patent Application No. 1318138. 3 filed Oct. 14, 2013, which is incorporated herein by reference in its entirety.

### TECHNICAL FIELD

The technical field relates to a method of controlling the boost pressure of a turbocharger, in particular a turbocharger provided with a vacuum or boost pressure actuated waste gate valve. The method is suitable for internal combustion engines, and in particular enables use of vacuum or boost pressure actuators, controlled by an electric pneumatic pressure valve or vacuum control valve, in gasoline turbocharged engines.

### BACKGROUND

As known, the majority of internal combustion engines are turbocharged. A turbocharger is a forced induction device used to allow more power to be produced for an engine of a given size. The benefit of a turbo is that it compresses a greater mass of intake air into the combustion chamber, thereby resulting in increased power and/or efficiency. Turbochargers are commonly used on truck, car, train and construction equipment engines. They are popularly used with Otto cycle and Diesel cycle internal combustion engines and have also been found useful in automotive fuel cells.

As also known, a turbocharged engine system utilizes a waste gate valve, which is a valve that diverts exhaust gases away from the turbine. Diversion of exhaust gases regulates the turbine speed, which in turn regulates the rotating speed of the compressor. The primary function of the waste gate is to regulate the boost pressure in turbocharger systems, in order to set the desired air per cylinder and to protect the engine as well as the turbocharger. The waste gate valve is controlled by an internal combustion engine controller (for example an electronic control unit or ECU). A possible way to manage the waste gate is via a waste gate actuator also called vacuum control valve or electric pneumatic pressure valve (EPV). This valve is electrically actuated by the ECU via a pulse width modulated signal (PWM), expressed as a duty cycle (DC) in percentage. As known, pulse width modulated (PWM) is a modulated technique that conforms the width of the pulse, formally the pulse duration, based on a modulator signal information. The average value of voltage (and current) fed to the load is controlled by turning the switch between supply and load on and off at a fast rate. The longer the switch is on compared to the off periods, the higher the power that is supplied to the load. The term duty cycle describes the proportion of ‘on’ time to the regular interval or ‘period’ of time. A low duty cycle corresponds to low power, because the power is off for most of the time. As mentioned, duty cycle is normally expressed in percent, 100% being fully on. Hereafter the term “duty cycle” will always indicate a percentage value.

The EPV determines the vacuum pressure of the air, which is fed by a vacuum pump. This negative air pressure (vacuum force) pushes against the force of a spring located in the waste gate actuator. The spring force allows the waste gate to open and re-direct exhaust gas so that it does not reach the turbine wheel, while the vacuum force realizes the closing of the waste gate. For boost pressure actuated systems, the EPV determines a control pressure, which is a mix of boost pressure and ambient pressure (or below). The control pressure pushes against a diaphragm, which is connected to a spring and the waste gate rod. The spring force hold the waste gate closed. If the control pressure increases and overcome a pressure threshold (known as basic boost pressure), the waste gate will be pushed in the open direction. This turbocharged engine control works pretty well if the engine is operating in warm conditions.

On the contrary, when the internal combustion engine is operating under cold temperature conditions, high pressure overshoots of the turbocharger have been observed. Some experimental tests have shown that the temperature of the solenoid of the waste gate actuator is responsible for boost pressure overshoots of the turbocharger. In fact, as known, the solenoid electrical resistance increases with the temperature. This means that, for a given duty cycle value, under cold temperature conditions, the electrical resistance of the solenoid decreases and the electrical current flowing in the solenoid increases. As a consequence, the waste gate will be closer, thus incrementing the boost pressure. In conclusion, a cold solenoid of the waste gate actuator leads to higher boost pressure compared to a warm solenoid with a similar duty cycle.

Therefore a need exists for a method of controlling the boost pressure of a turbocharger by considering the influence of the temperature of the waste gate actuator.

### SUMMARY

The present disclosure provides a method, by an apparatus, by an engine, by a computer program and computer program product for controlling boost pressure. An embodiment of the present disclosure provides a method of controlling the boost pressure of a turbocharger which takes into account the influence of the temperature of the waste gate actuator, above all when the engine is operating under cold temperature conditions. Another embodiment of the present disclosure provides an apparatus which allows to perform the above method. These objects are achieved by having the features recited in the independent claims.

The present disclosure provides a method of controlling a boost pressure of a turbocharger of an internal combustion engine, the turbocharger including a waste gate valve and a waste gate actuator when the internal combustion engine operates under cold temperature conditions. The method includes: determining a steady state temperature of the waste gate actuator; estimating a corrected temperature of the waste gate actuator as a function of the thermal convection between ambient air and the waste gate actuator; estimating a corrected value of the duty cycle of a pulse width modulated signal, as a function of the corrected temperature; and operating the duty cycle corrected value to control the boost pressure of the turbocharger.

Consequently, an apparatus is disclosed for performing the method of controlling a boost pressure of a turbocharger of an internal combustion engine including: means for determining a steady state temperature of the waste gate actuator; means for estimating a corrected temperature of the waste gate actuator as a function of the thermal convection between ambient air and the waste gate actuator; means for estimating a corrected value of the duty cycle of a pulse width modulated signal, as a function of the corrected temperature; and means for operating the duty cycle corrected value to control the boost pressure of the turbocharger.

An advantage of these embodiments is that the method controls the boost pressure of the turbocharger by modeling the temperature of the solenoid of the waste gate actuator. In this way, a corrected value of such temperature is calculated, taking into account the thermal convection between under hood air temperature and the solenoid coil of the waste gate actuator. By estimating the current temperature of the solenoid, which will be different under cold temperature conditions by the steady state temperature the solenoid reaches under normal driving condition with a warmed engine, it is therefore possible to correct the duty cycle value of the pulse width modulated signal supplied to the waste gate actuator; in particular, such DC value will be reduced, in order not to obtain a higher boost pressure of the turbocharger.

According to another embodiment, the method further includes the steps of calculating a waste gate actuator current, as a function of a waste gate actuator voltage and the corrected temperature of the waste gate actuator, and using the waste gate actuator current to estimate the corrected value of the duty cycle of the pulse width modulated signal.

Consequently, the apparatus further includes means for calculating a waste gate actuator current, as a function of a waste gate actuator voltage and the corrected temperature of the waste gate actuator, and means for using the waste gate actuator current to estimate the corrected value of the duty cycle of the pulse width modulated signal.

An advantage of this embodiment is that the corrected value of the duty cycle of the pulse width modulated signal is estimated taking into account also the current flowing in the solenoid. In other words, the duty cycle value is determined in one shot taking into account both influencing parameters, the solenoid temperature and the electrical current, which on its turn depends on the solenoid voltage.

According to a further embodiment, the waste gate actuator voltage is the sum of a supply voltage and a voltage due to a coil inductance. Consequently, the means for calculating a waste gate actuator current, as a function of a waste gate actuator voltage, are configured to use the waste gate actuator voltage as the sum of a supply voltage and a voltage due to a coil inductance. In this way the corrected value of the duty cycle of a pulse width modulated signal is estimated also taking into account the specific characteristic of the solenoid coil.

According to a still further embodiment, the thermal convection between ambient air and the waste gate actuator is a function of a duty cycle value of the pulse width modulated signal. Consequently, the means for estimating a corrected temperature of the waste gate actuator as a function of the thermal convection between ambient air and the waste gate actuator are configured to calculate the thermal convection as a function of a duty cycle value of the pulse width modulated signal. An advantage of this embodiment is that the thermal convection between ambient air and the waste gate actuator is calculated by taking into account the most influencing parameter, which is the value of the DC of the pulse width modulated signal.

According to a still further embodiment, the thermal convection between ambient air and the waste gate actuator is also a function of a vehicle speed and an engine coolant temperature. Consequently, the means for estimating a corrected temperature of the waste gate actuator as a function of the thermal convection between ambient air and the waste gate actuator are configured to calculate the thermal convection also as a function of a vehicle speed and an engine coolant temperature. In this way, the temperature model of the solenoid of the waste gate actuator does not disregard other influencing parameters.

According to still another embodiment the steady state temperature of the waste gate actuator depends on the engine coolant temperature, the duty cycle of the pulse width modulated signal and an intake manifold temperature. Consequently, the means for determining a steady state temperature of the waste gate actuator are configured to operate with a steady state temperature of the waste gate actuator, which depends on the engine coolant temperature, the duty cycle of the pulse width modulated signal and an intake manifold temperature. In this way, the temperature model of the solenoid of the waste gate actuator does not disregard the influencing parameters determining the temperature steady state conditions.

Another embodiment of the disclosure provides an internal combustion engine including a turbocharger, a waste gate valve and a waste gate actuator, wherein a boost pressure of the turbocharger is controlled by a method according to any of the preceding embodiments.

The method according to one of its aspects can be carried out with the help of a computer program including a program-code for carrying out all the steps of the method described above, and in the form of computer program product including the computer program. The computer program product can be embedded in a control apparatus for an internal combustion engine, including an Electronic Control Unit (ECU), a data carrier associated to the ECU, and the computer program stored in a data carrier, so that the control apparatus defines the embodiments described in the same way as the method. In this case, when the control apparatus executes the computer program all the steps of the method described above are carried out.

### BRIEF DESCRIPTION OF THE DRAWINGS

The present disclosure will hereinafter be described in conjunction with the following drawing figures, wherein like numerals denote like elements.

FIG. 1 shows an automotive system;

FIG. 2 is a section of an internal combustion engine belonging to the automotive system of FIG. 1;

FIG. 3 is a schematic overview of a turbocharged internal combustion engine;

FIG. 4 is a flowchart of the method according to an embodiment of the present disclosure; and

FIG. 5 is a flowchart of the method according to a further embodiment of the present disclosure.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

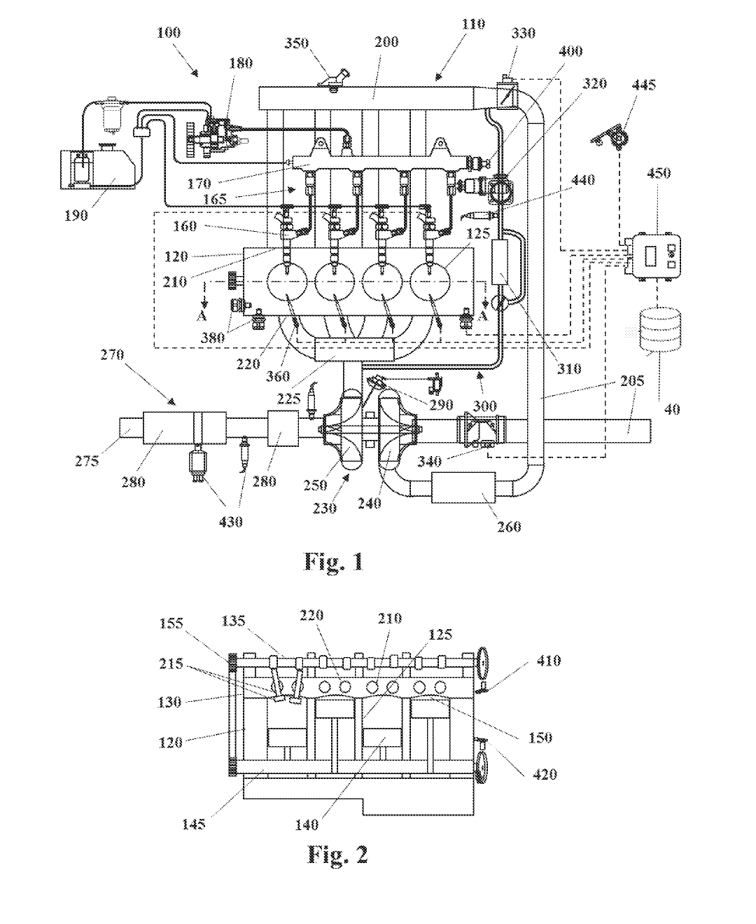

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150.

A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump 180 that increase the pressure of the fuel received from a fuel source 190.

Each of the cylinders 125 has at least two valves 215, actuated by a camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a fixed geometry turbine 250 including a waste gate 290. In other embodiments, the turbocharger 230 may be a variable geometry turbine (VGT) with a VGT actuator arranged to move the vanes to alter the flow of the exhaust gases through the turbine.

The exhaust system 270 may include an exhaust pipe 275 having one or more exhaust after-treatment devices 280. The after-treatment devices may be any device configured to change the composition of the exhaust gases. Some examples of after-treatment devices 280 include, but are not limited to, catalytic converters (two and three way), oxidation catalysts, lean NOx traps, hydrocarbon adsorbers, selective catalytic reduction (SCR) systems. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110 and equipped with a data carrier 40. The ECU 450 may receive input signals from various sensors configured to generate the signals in proportion to various physical parameters associated with the ICE 110. The sensors include, but are not limited to, a mass airflow, pressure, temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel injectors 160, the throttle body 330, the EGR Valve 320, the waste gate actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices. The program may embody the methods disclosed herein, allowing the CPU to carryout out the steps of such methods and control the ICE 110.

The program stored in the memory system is transmitted from outside via a cable or in a wireless fashion. Outside the automotive system 100 it is normally visible as a computer program product, which is also called computer readable medium or machine readable medium in the art, and which should be understood to be a computer program code residing on a carrier, the carrier being transitory or non-transitory in nature with the consequence that the computer program product can be regarded to be transitory or non-transitory in nature.

An example of a transitory computer program product is a signal, e.g. an electromagnetic signal such as an optical signal, which is a transitory carrier for the computer program code. Carrying such computer program code can be achieved by modulating the signal by a conventional modulated technique such as QPSK for digital data, such that binary data representing the computer program code is impressed on the transitory electromagnetic signal. Such signals are e.g. made use of when transmitting computer program code in a wireless fashion via a Wi-Fi connection to a laptop.

In case of a non-transitory computer program product the computer program code is embodied in a tangible storage medium. The storage medium is then the non-transitory carrier mentioned above, such that the computer program code is permanently or non-permanently stored in a retrievable way in or on this storage medium. The storage medium can be of conventional type known in computer technology such as a flash memory, an Asic, a CD or the like.

Instead of an ECU 450, the automotive system 100 may have a different type of processor to provide the electronic logic, e.g. an embedded controller, an onboard computer, or any processing module that might be deployed in the vehicle.

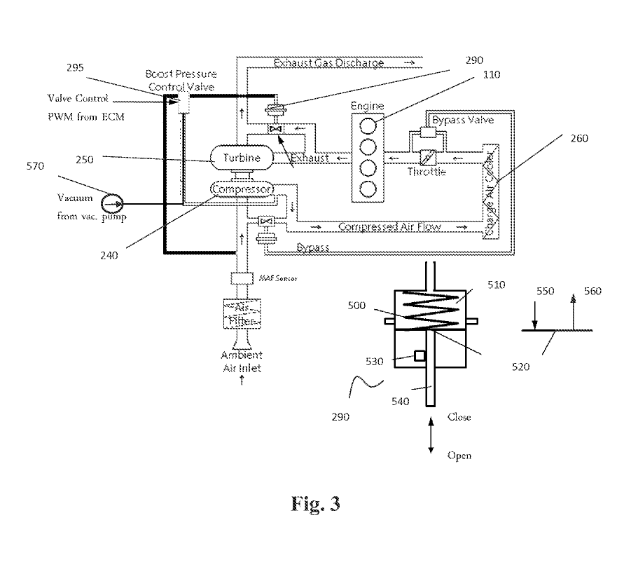

FIG. 3 is a schematic overview of a turbocharged internal combustion engine. In the scheme, other than the compressor 240 and the turbine 250, is shown a vacuum pump 570, a waste gate valve 290 and an electric pneumatic pressure valve (EPV) 295, i.e. the waste gate actuator. The EPV determines the vacuum or boost pressure of the air, which is fed by a vacuum pump or through a hose after the compressor. This vacuum or boost air pressure as well as the ambient pressure will be set with the solenoid as control pressure 510 which pushes against the force of a spring 500 located in the waste gate valve 290. The force scheme is shown on the bottom right of the same picture: at the spring force 550 is opposed a variable vacuum or boost force 560. The resulting force acts on a membrane 520, which, due to its strain, moves a waste gate rod 540 up and down, allowing the waste gate valve to open and re-direct exhaust gases, so that a smaller exhaust mass flow will be fed to the turbine wheel, or to close letting the exhaust gases flow through the turbine 250.

The force scheme in FIG. 3 is related to vacuum actuated waste gate. For boost actuated waste gate, the spring force held the waste gate closed, while if the control pressure increases and overcome a pressure threshold the waste gate will be pushed in the open direction. A rod position sensor 530 can be used to control the position of the waste gate rod. To regulate the boost pressure (p_{boost}), the ECU controls the waste gate valve 290 via a PWM signal to the electric pneumatic pressure valve (or waste gate actuator) 295. The EPV determines the vacuum or boost pressure of the air and consequently the opening/closing of the waste gate valve by means of the waste gate rod 540 movement. Its movement can monitored by a rod position sensor 530, if available.

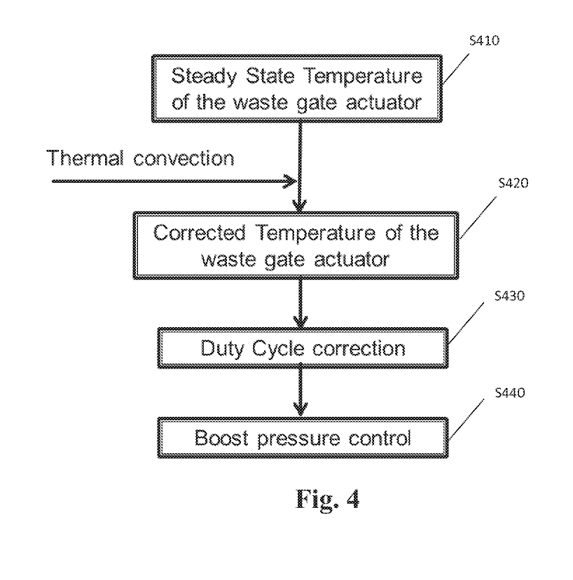

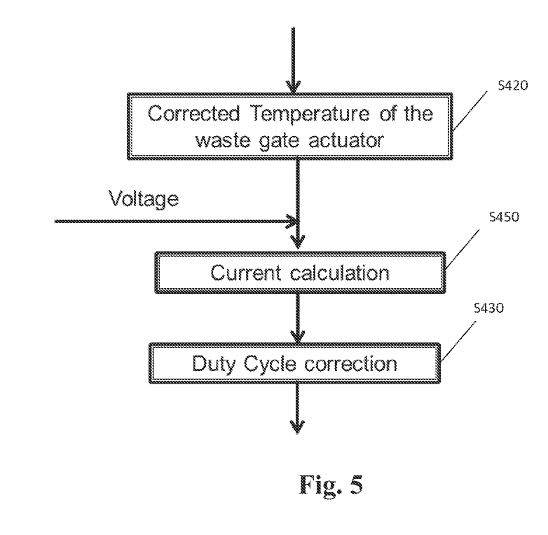

When the internal combustion engine is operating under cold temperature conditions, a temperature model of the solenoid of the waste gate actuator has to be setup and used for the control of the boost pressure of the turbocharger. In particular, FIG. 4 shows a high level flowchart, according to an embodiment of the present disclosure. According to the flowchart, at first a steady state temperature (Tₛₛ) of the waste gate actuator is estimated S410.

The steady state temperature of the waste gate actuator depends on the engine coolant temperature and the intake manifold temperature. In detail, under normal engine driving conditions, such steady state temperature will be the sum of a filtered intake manifold temperature and a temperature offset, which is a function of the DC value; when the engine is idling such temperature will depends only on the engine coolant temperature; finally, when the engine is not running but the key is on and the steady state coil temperature (Tss) need to be initialized, the value will be half of the sum between the intake manifold temperature and the engine coolant temperature.

Then the present method will estimate S420 a corrected temperature (T_{corr}) of the waste gate actuator as a function of the thermal convection between ambient air and the waste gate actuator. The thermal convection between ambient air (mainly under hood air) and the waste gate actuator is above all a function of a duty cycle value of the pulse width modulated signal, which is correlated to the turbocharger temperature. The thermal convection between ambient air and the waste gate actuator is also a function of vehicle speed, duty cycle of the PWM signal and engine coolant as well as intake manifold temperature. Even if the impact of such parameters can be almost negligible, according to an alternative embodiment of the present method, such parameters are also taken into account.

Then the method estimates S430 a corrected value (PWM_{corr}) of the duty cycle of the pulse width modulated signal, as a function of the corrected temperature (T_{corr}) of the waste gate actuator. This is practically realized by using a first map (corrected duty cycle value vs. corrected solenoid temperature). Finally, the method operates S440 the duty cycle corrected value (PWM_{corr}) to control the boost pressure (p_{boost}) of the turbocharger 230.

Therefore, according to this embodiment, the duty cycle correction is achieved by directly using the corrected temperature of the solenoid. Of course the duty cycle value needs to be corrected also by taking into account the voltage in the inductance of the solenoid. A second map (duty cycle vs. voltage) can be provided at this purpose.

As an alternative, the method further include the steps of calculating S450 a waste gate actuator current (I), as a function of a waste gate actuator voltage (U) and using the waste gate actuator current to estimate the corrected value (PWM_{corr}) of the duty cycle of the pulse width modulated signal. In other words, the corrected temperature (T_{corr}) of the waste gate actuator can be used for calculating the coil resistance and, knowing the solenoid voltage, the electrical current which can be used as an input parameter of a duty cycle correction table. This alternative embodiment has the advantage to cover both voltage and temperature influences on the waste gate actuator, by using only one map instead of two, as in the previous embodiment.

In detail the coil electrical current is calculated as follows by using the Ohm law:

$$I = \frac{U}{{R}_{coil}}$$

### Where:

I=coil electrical current;

U=voltage; and

R_{coil}=coil electrical resistance

The waste gate actuator voltage (U) is the sum of a supply voltage (U_{supply}) and a voltage (U_{ind}) due to the coil inductance. The supply voltage is a known parameter, while the second term is the inductance L multiplied by the time derivative of the current:

$${U}_{ind} = L * \frac{d I}{d t}$$

and for a coil, the inductance will be equal to:

L=N²x (μ₀x μᵣx A)/1

### Where:

N=number of wire turns in coil;

μ0=magnetic constant;

μr=relative magnetic permeability;

1=length of the coil; and

A=cross section area

The present method has the advantage not to require a big calibration effort. In fact, the calibration is physics based and data are available for temperature compensation (solenoid temperature vs. duty cycle). The temperature model is quite simple, depending on engine coolant, manifold temperature and vehicle speed to be calibrated. By using such solenoid temperature compensation, the drivability is improved, since an improved boost control by improved boost feed forward accuracy, leading to both reduced boost overshoots at cold engine conditions and boost undershoots at hot engine conditions respectively. Furthermore, the method increases the in respect to the diagnosis (deviation from normal operating conditions), has an improved and more robust adaptation, which is very important as the hardware is pushed very close to its limits (hardware protection).

While at least one exemplary embodiment has been presented in the foregoing detailed description, it should be appreciated that a vast number of variations exist. It should also be appreciated that the exemplary embodiment is only an example, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

1-10. (canceled)

11. A method of controlling a boost pressure of a turbocharger of an internal combustion engine operating under cold temperature conditions, the turbocharger having a waste gate valve and a waste gate actuator, the method comprising:
determining a steady state temperature of a waste gate actuator;
estimating a corrected temperature of the waste gate actuator as a function of the thermal convection between ambient air and the waste gate actuator;
estimating a duty cycle corrected value of a pulse width modulated control signal for a waste gate actuator as a function of said corrected temperature; and
generating a temperature corrected control signal based on said duty cycle corrected value to control the waste gate actuator for adjusting a boost pressure of the turbocharger.

12. The method according to claim 11 further comprising controlling the waste gate actuating using the temperature corrected control signal to adjust the boost pressure of the turbocharger.

13. The method according to claim 11, wherein the method further comprises:
calculating a waste gate actuator current, as a function of a waste gate actuator voltage and the corrected temperature of the waste gate actuator; and
estimating the duty cycle corrected value of the pulse width modulated signal using said waste gate actuator current.

14. The method according to claim 11, wherein the waste gate actuator voltage comprises a sum of a supply voltage and an induced voltage due to a coil inductance.

15. The method according to claim 11, wherein said thermal convection between ambient air and the waste gate actuator is a function of a duty cycle value of the pulse width modulated signal.

16. The method according to claim 15, wherein said thermal convection between ambient air and the waste gate actuator is also a function of a vehicle speed and an engine coolant temperature.

17. The method according to claim 11, further comprising:
determining an engine coolant temperature and an intake manifold temperature; and
estimating said steady state temperature estimate of the waste gate actuator as a function of the engine coolant temperature, the duty cycle of the pulse width modulated signal and the intake manifold temperature.

18. An internal combustion engine comprising a turbocharger, a waste gate valve and a waste gate actuator, wherein a boost pressure of the turbocharger is controlled by a method according to claim 11.

19. A non-transitory computer program comprising a computer-code operable with a processor for performing the method according to claim 11.

20. A computer program product on which the non-transitory computer program according to claim 19 is stored.

21. A method of controlling a boost pressure of a turbocharger of an internal combustion engine operating under cold temperature conditions, the turbocharger having a waste gate valve and a waste gate actuator, the method comprising:
determining a steady state temperature of a waste gate actuator;
estimating a corrected temperature of the waste gate actuator, in a processor, as a function of the thermal convection between ambient air and the waste gate actuator;
estimating a duty cycle corrected value of a pulse width modulated control signal for a waste gate actuator, in the processor, as a function of said corrected temperature; and
generating a temperature corrected control signal based on said duty cycle corrected value, in the processor, to control the waste gate actuator for adjusting a boost pressure of the turbocharger.

22. A boost pressure control apparatus for an internal combustion engine, comprising:
a turbocharger having a waste gate valve and a waste gate actuator controlling the waste gate valve and configured to adjust the boost pressure for an internal combustion engine;
an electronic control unit and a computer program product stored in non-transitory computer readable medium having a computer-code operable with the electronic control unit to execute the following steps:
determine a steady state temperature of the waste gate actuator;
estimate a corrected temperature of the waste gate actuator as a function of the thermal convection between ambient air and the waste gate actuator;
estimate a duty cycle corrected value of a pulse width modulated control signal for a waste gate actuator as a function of said corrected temperature;
generate a temperature corrected control signal based on said duty cycle corrected value to control the waste gate actuator for adjusting a boost pressure of the turbocharger; and
control the waste gate actuator using the temperature corrected control signal to adjust the boost pressure of the turbocharger.
